(19) United States
(12) Patent Application Publication
(10) Pub. No.: US 2010/0131369 A1
(43) Pub. Date: May 27, 2010

(54) GROUP ASSOCIATION SYSTEM AND METHOD

(76) Inventors: Richard Jude Dominguez, Temecula, CA (US); Michael Anthony Grimsley, Menifee, CA (US); Luc Doan, Murrieta, CA (US)

Correspondence Address: HOLLAND & KNIGHT LLP, 10 ST. JAMES AVENUE, BOSTON, MA, 02116-3889, US

(21) Appl. No.: 12/324,591

(22) Filed: Nov. 26, 2008

(51) Int. Cl. G06Q 10/00; G06Q 90/00; G06Q 30/00; G06Q 50/00

(52) U.S. Cl. 705/14.67; 705/500; 705/30; 705/14.25; 705/14.3

(57) ABSTRACT

A method, system, and computer program product defines an identity of a patron of a casino. Whether the patron has an account within the casino is determined. If the patron has an account, the account associated with the patron is determined. If the patron does not have an account, an account is generated and associated with the patron. The account is associated with a group of patrons.

### TECHNICAL FIELD

This disclosure relates to membership systems and, more particularly, to establishing group association within a membership system.

### BACKGROUND

Many establishments maintain customer loyalty programs. A patron becomes a member of the program typically by providing his or her name and address to the establishment. A membership card is given to the patron and subsequently scanned or swiped upon each visit to or transaction within the establishment. Details of the patron's membership (e.g., identity, member number) are stored by a membership system. The patron benefits from the membership by receiving discounts and promotional offers, and the establishment benefits from the membership by being able to track valuable market data. This may include information such as: how much money an individual has spent at the establishment, what products or services are more popular among customers from various regions, how one product correlates to another (e.g., whether people who buy product A tend to also buy product B), whether promotional mailings are successful, and many others.

In some cases, a group of patrons all arrive at once, and an establishment wants to A) associate each patron as a member of the group that arrived together, and B) give a new account (and membership card) to any patron who is not already a member of the customer loyalty program. Typically, each patron is requested to go to a customer service desk during their visit and register their arrival with the group. While there, the patron will establish an account in the customer loyalty program if he or she does not already have one. This procedure is typically too slow to handle a group of people in a timely fashion, and there is no guarantee that each patron will do as requested. Of the patrons that do, some may become frustrated by any resulting delay or may harbor a negative impression if a lengthy procedure is imposed upon them. Such patrons may not spend as much money at the establishment as they otherwise might have. Even if the patrons are not annoyed by the procedure, the time spent waiting to register, or to establish a new account, is time they might have otherwise been spending money in the establishment.

### SUMMARY OF THE DISCLOSURE

In a first implementation, a method includes defining an identity of a patron of a casino. Whether the patron has an account within the casino is determined. If the patron has an account, the account associated with the patron is determined. If the patron does not have an account, an account is generated and associated with the patron. The account is associated with a group of patrons.

One or more of the following features may be included. Defining an identity of a patron may include processing encoded data to define the identity. Defining an identity of a patron may include defining the identity on a handheld device.

A membership card may be generated and the membership card maybe associated with the account. A personal identification number may be associated with one or more of the account and a membership card. A promotional credit may be issued. Associating the account with the patron may include defining one or more of membership data and group association data. One or more of the membership data and group association data may be provided to one or more of a membership system and a promotions system.

In another implementation, a system is configured to perform operations including defining an identity of a patron of a casino. Whether the patron has an account within the casino is determined. If the patron has an account, the account associated with the patron is determined. If the patron does not have an account, an account is generated and associated with the patron. The account is associated with a group of patrons.

One or more of the following features may be included. Defining an identity of a patron may include processing encoded data to define the identity. Defining an identity of a patron may include defining the identity on a handheld device.

A membership card may be generated and the membership card maybe associated with the account. A personal identification number may be associated with one or more of the account and a membership card. A promotional credit may be issued. Associating the account with the patron may include defining one or more of membership data and group association data. One or more of the membership data and group association data may be provided to one or more of a membership system and a promotions system.

In another implementation, a computer program product resides on a computer readable medium that has a plurality of instructions stored on it. When executed by a processor, the instructions cause the processor to perform operations including defining an identity of a patron of a casino. Whether the patron has an account within the casino is determined. If the patron has an account, the account associated with the patron is determined. If the patron does not have an account, an account is generated and associated with the patron. The account is associated with a group of patrons.

One or more of the following features may be included. Defining an identity of a patron may include processing encoded data to define the identity. Defining an identity of a patron may include defining the identity on a handheld device.

A membership card may be generated and the membership card maybe associated with the account. A personal identification number may be associated with one or more of the account and a membership card. A promotional credit may be issued. Associating the account with the patron may include defining one or more of membership data and group association data. One or more of the membership data and group association data may be provided to one or more of a membership system and a promotions system.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a promotional association system coupled to a distributed computing network;

FIG. 2 is a flowchart of the process executed by the promotional association system of FIG. 1;

FIG. 3 is a more detailed flowchart of a portion of the process shown in FIG. 2; and

FIG. 4 is a more detailed flowchart of a portion of the process shown in FIG. 2.

Like reference symbols in the various drawings indicate like elements.

### DETAILED DESCRIPTION OF THE DISCLOSURE

### System Overview:

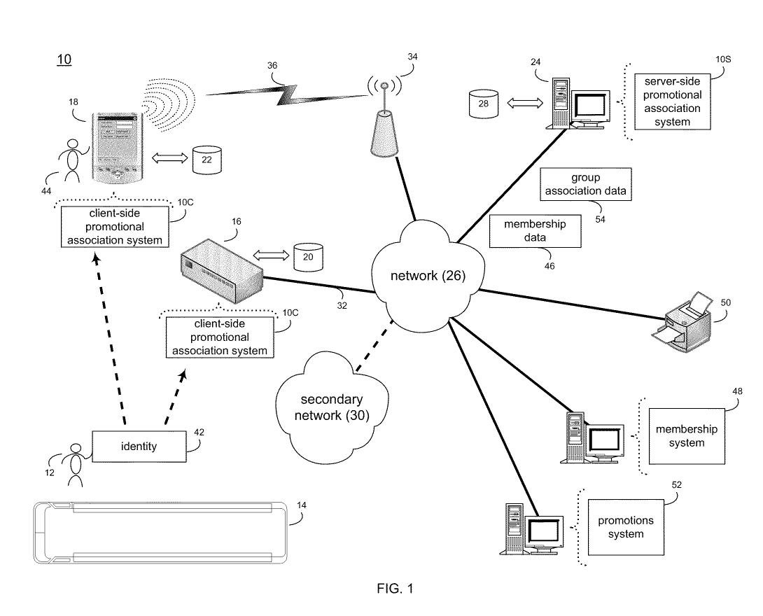

Referring to FIG. 1, there is shown promotional association system 10. As will be discussed below in greater detail, when a patron (e.g., patron 12) arrives at an establishment as a member of a group of patrons (e.g., a group of patrons on bus 14), it may be desirable to associate patron 12 as a member of the group (i.e., make a record of the fact that patron 12 arrived as part of the group on bus 14). It may be desirable to do so by e.g., associating the group membership with the patron's customer loyalty program account, and if the patron does not have an account, it may be desirable to establish a new account for patron 12. Associating the account of patron 12 with e.g., the group from bus 14, including generating an account if necessary, may be effectuated by promotional association system 10.

The account/membership in question could be one of, for example, a rewards account, a customer loyalty program account, a credit account, a debit account, or a service account (e.g., at an auto shop or utility company). Examples of customer loyalty programs may include membership accounts or rewards accounts, for example: a frequent flyer account, a casino player's club account, a hotel rewards club account, or a grocery store ‘valued customer’ account.

In such a case, the patron may present an account/membership card, which may include encoded data. All or a portion of the encoded data may be processed on a stationary scanner/reader (e.g., stationary device 16) or on a handheld device (e.g., handheld device 18). Examples of stationary device 16 may include but are not limited to a kiosk, an overhead or frame-mounted reader/scanner, a point-of-sale-type card reader, or a pedestal-mounted reader/scanner. Examples of handheld device 18 may include but are not limited to a personal digital assistant, a laptop computer, a notebook computer, and a specialized device.

Promotional association system 10 may include a client-side portion (e.g., client-side promotional association system 10C) and a server-side portion (e.g., server-side promotional association system 10S) that may work cooperatively to effectuate the functionality of promotional association system 10.

Stationary device 16 may include various instruction sets and subroutines (e.g., client-side promotional association system 10C), which may be stored on storage device 20 coupled to/included within stationary device 16 and may be executed by one or more processors (not shown) and one or more memory architectures (not shown) incorporated into stationary device 16.

Examples of storage device 20 may include but are not limited to: a hard disk drive; a random access memory (RAM); a read-only memory (ROM), a compact flash (CF) storage device, a secure digital (SD) storage device, and a memory stick storage device. Stationary device 16 may run an operating system, examples of which may include but are not limited to: Microsoft Windows™, Microsoft Windows CE™, Redhat Linux™, PalmOS™, Apple Mac OS X™, or a custom operating system.

Handheld device 18 may include various instruction sets and subroutines (e.g., client-side promotional association system 10C), which may be stored on storage device 22 coupled to/included within handheld device 18 and may be executed by one or more processors (not shown) and one or more memory architectures (not shown) incorporated into handheld device 18.

Examples of storage device 22 may include but are not limited to: a hard disk drive; a random access memory (RAM); a read-only memory (ROM), a compact flash (CF) storage device, a secure digital (SD) storage device, and a memory stick storage device. Handheld device 18 may run an operating system, examples of which may include but are not limited to: Microsoft Windows™, Microsoft Windows CE™, Redhat Linux™, PalmOS™, Apple Mac OS X™, or a custom operating system.

Server-side promotional association system 10S may reside on and may be executed by server computer 24, which may be coupled to network 26 (e.g., the Internet or a local area network). Examples of server computer 24 may include, but are not limited to: a personal computer, a server computer, a series of server computers, a mini computer, and a mainframe computer. Server computer 24 may be a single server or a series of servers running a network operating system, examples of which may include but are not limited to: Microsoft Windows 2003 Server™; Novell Netware™; or Redhat Linux™, for example.

The instruction sets and subroutines of server-side promotional association system 10S, which may be stored on storage device 28 coupled to/included within server computer 24, may be executed by one or more processors (not shown) and one or more memory architectures (not shown) incorporated into server computer 24. Examples of storage device 28 may include but are not limited to: a hard disk drive; a tape drive; an optical drive; a RAID array; a random access memory (RAM); and a read-only memory (ROM).

Stationary device 16 may be coupled to distributed computing network 26 (e.g., the Internet or a local area network). Handheld device 18 may also be coupled to distributed computing network 26. Server computer 24 may be connected to network 26 and may execute a server application, examples of which may include but are not limited to: Microsoft IIS™, Novell Webserver™, or Apache Webserver™, that allows for access to server computer 24 via network 26. Network 26 may be connected to one or more secondary networks (e.g., network 30), examples of which may include but are not limited to: a local area network; a wide area network; or an intranet, for example.

Stationary device 16 may be directly or indirectly coupled to network 26, or network 30, or server computer 24. For example, stationary device 16 is shown directly coupled to network 26 via wired communication channel 32 that may be effectuated using e.g., an Ethernet port (IEEE 802.3), a Token Ring port (IEEE 802.5), a Universal Serial Bus (i.e., USB) port, an IEEE 1394 port, a parallel port, and/or a serial port that is capable of coupling stationary device 16 to network 26. Stationary device 16 may additionally/alternatively be coupled to network 26 via a wireless communication channel (not shown) established between stationary device 16 and wireless access point 34, which is shown directly coupled to network 26. Wireless access point 34 may be, for example, an IEEE 802.11a, 802.11b, 802.11g, Wi-Fi, IEEE 802.15, Bluetooth, and/or infrared device that is capable of establishing a wireless communication channel (not shown) between stationary device 16 and wireless access point 34.

Handheld device 18 may be directly or indirectly coupled to network 26, or network 30, or server computer 24. For example, handheld device 18 is shown wirelessly coupled to network 26 via wireless communication channel 36 established between handheld device 18 and wireless access point 34, which is shown directly coupled to network 26. Wireless access point 34 may be, for example, an IEEE 802.11a, 802.11b, 802.11g, Wi-Fi, IEEE 802.15, Bluetooth, and/or infrared device that is capable of establishing wireless communication channel 36 between handheld device 18 and wireless access point 34. Handheld device 18 may additionally/alternatively be coupled to network 26 via a wired communication channel (not shown) effectuated using e.g., a Universal Serial Bus (i.e., USB) port, an IEEE 1394 port, an Ethernet port, a parallel port, and/or a serial port that is capable of coupling handheld device 18 to network 26 or server computer 24.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless interface.

Promotional association system 10 (e.g., client-side promotional association system 10C and/or server-side promotional association system 10S) may work cooperatively with an existing membership system (e.g., membership system 38) that maintains the accounts of patrons (e.g., a membership database) and/or an existing promotions system (e.g., promotions system 40) that maintains marketing, promotional, and/or group information. Promotional association system 10 may be closely integrated with an existing system (e.g., membership system 38 or promotions system 40). For example, server-side promotional association system 10S may be executed on the same computer platform as membership system 38 and/or promotions system 40, and server-side promotional association system 10S may be implemented as an add-on, plug-in, or API (Application Programming Interface) in conjunction with membership system 38 or promotions system 40.

### System Operation:

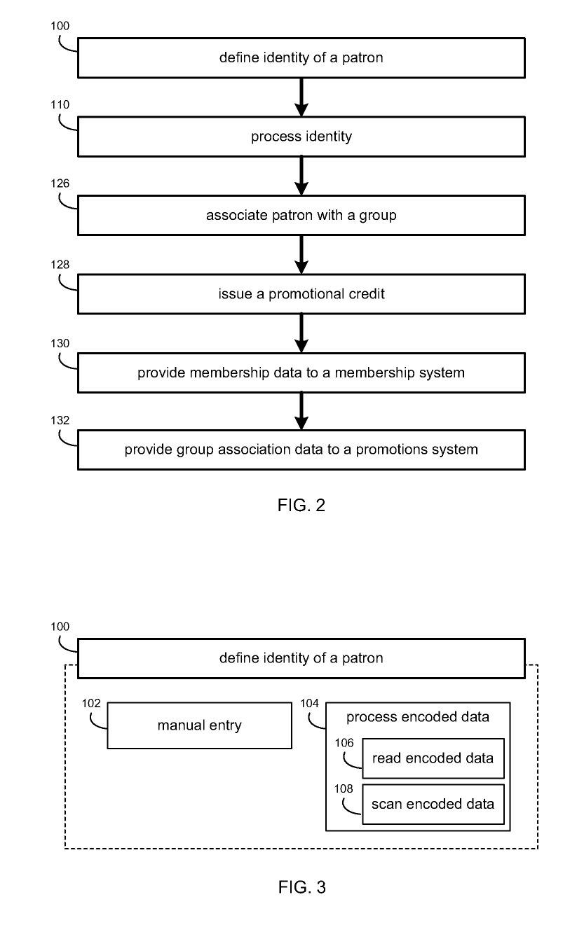

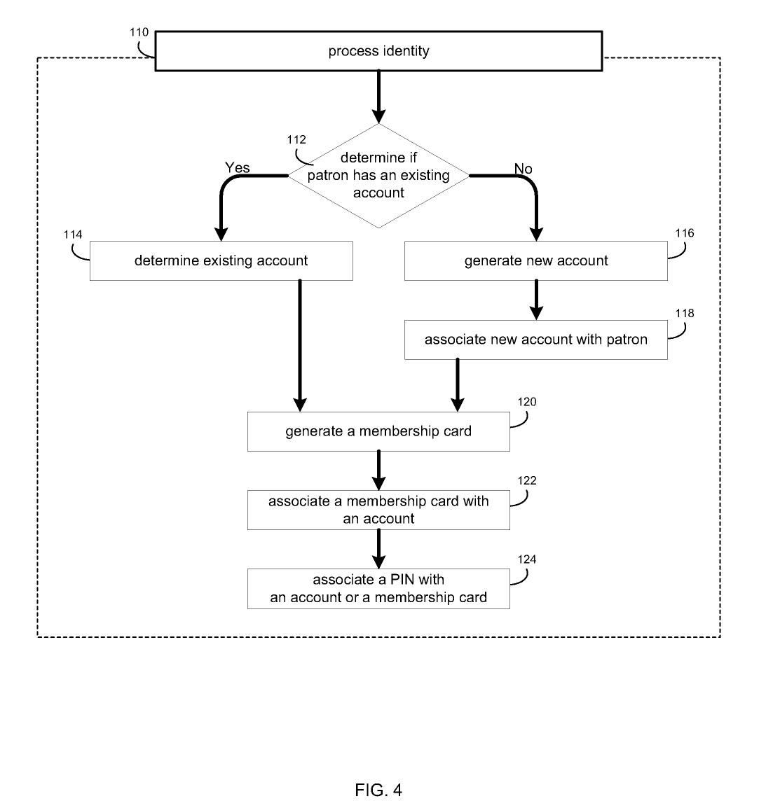

Referring also to FIGS. 2-4, assume that patron 12 arrives as part of a group (e.g., on tour bus 14) at an establishment. Further assume that he or she may present some form of identification. Promotional association system 10 may be used to associate patron 12 with the arriving group.

Identity 42 of patron 12 may be defined 100 (at least in part) by employee 44, who may manually enter 102 identity 42 into stationary device 16 or handheld device 18. Identity 42 may be defined 100 by e.g., employee 44 asking patron 12 for his/her identity and/or asking patron 12 to provide a form of identification. The requisite information may then be manually entered 102 into stationary device 16 or handheld device 18 through, e.g., a keypad or touch screen (not shown).

In another embodiment, identity 42 may be defined 100 by processing 104 data that is encoded within some form of identification, examples of which may include but are not limited to: a driver's license, a membership card (such as a customer loyalty card), a credit card, a proximity card, a passport, or any other government-issued or privately-issued identification, or may be a biological credential (e.g., fingerprints, retinal scans, or facial likeness). Data may be encoded using a variety of methodologies, examples of which may include but are not limited to: a magnetic strip, a barcode, an optical code, an RFID tag, an image, or text.

For the purposes of this disclosure, biological credentials such as fingerprints, retinal scans, and facial likeness are understood to be forms of identification, and a fingerprint image, a retinal image, or facial image are understood to be encoded data, because from such images the identity of the associated person may be determined.

Processing 104 of encoded data may include reading 106 a magnetic strip, a barcode, an RFID tag, or an optical code; or may include scanning 108 an image, text, a fingerprint, a retina, or a facial likeness. Accordingly, stationary device 16 and/or handheld device 18 may include a magnetic strip reader (not shown), a barcode reader (not shown), an RFID reader (not shown), an optical scanner (not shown), or a biometric scanner/reader (not shown).

For example, a driver's license or a credit card of patron 12 may have data encoded within a magnetic strip. A magnetic strip reader (not shown) included within stationary device 16 or handheld device 18 may read 106 the magnetic strip when the driver's license of patron 12 is swiped through the card reader. Depending on the manner in which the magnetic strip is configured, the magnetic strip may directly contain the identity of patron 12 or may contain reference data from which the identity of patron 12 may be determined. For example, a record number or an account number may be defined within the magnetic strip, which may be used to determine the identity of patron 12 via a lookup operation performed on a database (e.g., a motor vehicle database or a bank credit account database).

The form of identification may not contain a magnetic strip but may include e.g., the name, address and/or photograph of patron 12. In such a case, stationary device 16 or handheld device 18 may e.g., scan 108 the driver's license (or other form of identification) with an included scanner (not shown) and may further process the scan by e.g., storing the scan as an image file, conducting optical character recognition to extract text-based data, and storing the text-based data. Additionally/alternatively, face recognition software (not shown) may be utilized to process a photograph included within the driver's license (or other form of identification) to identify patron 12 from the photograph and define identity 42.

As discussed above, identity 42 (as defined 100 on stationary device 16 or handheld device 18) may include the identity of patron 12 either directly (e.g., by name, address, social security number, etc.) or indirectly (e.g., by driver's license number, account number(s), photographic image, etc.). Additionally, other pieces of information may be included in identity 42, examples of which may include but are not limited to: identity of the user of stationary device 16 or handheld device 18 (e.g., employee 44), identity of stationary device 16 or handheld device 18, and date/time the information was entered into stationary device 16 or handheld device 18.

As discussed above, promotional association system 10 may include a client-side portion (e.g., client-side promotional association system 10C) and a server-side portion (e.g., server-side promotional association system 10S) that may work cooperatively to effectuate the functionality of promotional association system 10. Further and as discussed above, client-side promotional association system 10C may be executed on e.g., stationary device 16 and/or handheld device 18 and server-side promotional association system 10S may be executed on e.g., server computer 24.

In such a client-side/server-side implementation, at least a portion of identity 42 may be provided from client-side promotional association system 10C to server-side promotional association system 10S through any of a number of different interfaces and mechanisms. For example, either or both of stationary device 16 and handheld device 18 (i.e., a device that executes client-side promotional association system 10C) may be coupled to server computer 24 (i.e., the computer that executes server-side promotional association system 10S) via a direct cable interface, via a direct coupling to network 26, or via a wireless interface (e.g., wireless communication channel 36) as discussed above. Further, there may be a plurality of stationary devices (e.g., stationary device 16) and/or handheld devices (e.g., handheld device 18) that execute client-side promotional association system 10C and that are each coupled to server computer 24.

At least a portion of identity 42 may be stored by promotional association system 10. Specifically, all or a portion of identity 42 may be stored on a storage device (e.g., storage device 20 or storage device 22) coupled to a device that executes client-side promotional association system 10C (e.g., stationary device 16 or handheld device 18) and/or on a storage device (e.g., storage device 28) coupled to a computer that executes server-side promotional association system 10S (e.g., server computer 24).

At least a portion of identity 42 may be processed 110 by promotional association system 10 (i.e., client-side promotional association system 10C and/or server-side promotional association system 10S). Processing 110 at least a portion of identity 42 may include determining 112 whether patron 12 has an existing account. If it is determined 112 that patron 12 has an account, processing 110 at least a portion of identity 42 may include determining 114 the account associated with patron 12. Alternatively, if it is not determined 112 that patron 12 has an account, processing 110 may include generating 116 a new account and associating 118 the new account with patron 12. In either case, processing 110 at least a portion of identity 42 may also include generating 120 one or more membership cards and associating 122 the membership cards with the account. Further in either case, processing 110 at least a portion of identity 42 may also include associating 124 a Personal Identification Number (i.e., PIN) with an account or a membership card. In processing 110 at least a portion of identity 42, membership data 46 may be defined (to be discussed below in greater detail).

At least a portion of identity 42 may be processed 110 by promotional association system 10 (i.e., client-side promotional association system 10C and/or server-side promotional association system 10S) to determine 112 whether patron 12 has an existing account. To determine 112 whether patron 12 has an existing account, promotional association system 10 may perform a query against a membership database (not shown) maintained by a membership system (e.g., membership system 48) or may compare all or a portion of identity 42 to a list of patrons having accounts. For example, promotional association system 10 may provide all or a portion of identity 42 across network 26 to membership system 48 in order to effectuate determining 112 whether patron 12 has an existing account. This may be done in the form of a query, using structured query language (i.e., SQL), or may be done through some proprietary protocol supported by membership system 48. Alternatively, server-side promotional association system 10S may be implemented as a plug-in, add-on, or API coupled to membership system 48, as discussed above, and therefore a query may be performed as a local operation. In another embodiment, promotional association system 10 may download a list (not shown) of patrons having accounts from membership system 48 and compare identity 42 directly to the downloaded list (not shown). Further, promotional association system 10 may be pre-configured with a list (not shown) of patrons having accounts, which may be stored e.g., on one or more of storage devices 20, 22 and/or 28.

If it is determined 112 that patron 12 has an existing account, at least a portion of identity 42 may be processed 110 by promotional association system 10 (i.e., client-side promotional association system 10C and/or server-side promotional association system 10S) to determine 114 the account associated with patron 12. Determining 114 an account associated with patron 12 may include determining an account number or other account identifier, record number, or additional identifying information. To determine 114 the account, promotional association system 10 may perform a query against a membership database (not shown) maintained by membership system 48, or may compare all or a portion of identity 42 to a list of patrons having accounts. A successful query or a match within the list may result in an account number or other account identifier, record number, or additional account identifying information.

For example, promotional association system 10 may submit a query across network 26 to membership system 48 in order to determine 114 the account associated with patron 12. Alternatively, server-side promotional association system 10S may be implemented as a plug-in, add-on, or API coupled to membership system 48, as discussed above, and therefore a query may be performed as a local operation. In another embodiment, promotional association system 10 may download a list (not shown) of patrons having accounts from membership system 48 and compare identity 42 directly to the downloaded list (not shown). Further, promotional association system 10 may be pre-configured with a list (not shown) of patrons having accounts, which may be stored e.g., on one or more of storage devices 20, 22, or 28.

If it is not determined 112 that patron 12 has an existing account, processing at least a portion of identity 42 may include generating 116 a new account. Generating 116 a new account may include generating a new entry in a database (not shown) maintained by promotional association system 10 or membership system 48. Further, generating 116 a new account may include assigning an account number or other form of account identifier. Additionally, the new account may be associated 118 with patron 12 and/or identity 42. Associating 118 the new account with patron 12 nd/or identity 42 may include storing one or more pieces of information, such as but not limited to: an account number or identifier, all or a portion of identity 42, name, address, phone number, social security number, credit or debit account numbers, date of birth, or similar identifying and/or marketing information associated with patron 12.

Once determined 114 or generated 116, the account in question may be indistinguishable as to whether it was a new account or an existing account. Accordingly, further references will merely refer to “the account” and will not distinguish between a previously existing or a new account unless it is necessary for understanding the concepts discussed.

As introduced above, processing 110 at least a portion of identity 42 may also include generating 120 a membership card and associating 122 the membership card with the account. The membership card may be generated 120 by either client-side promotional association system 10C or server-side promotional association system 10S through a variety of mechanisms. For instance, stationary device 16 and/or handheld device 18 may be equipped with a card embosser (not shown), or promotional association system 10 may utilize a direct or network attached card embosser (e.g., printer/embosser 50) and may issue an instruction to membership system 48 to emboss a membership card (not shown). Such a membership card (not shown) may contain the identity of patron 12 and may contain an account number. The membership card (not shown) may also contain additional pieces of information, such as a control number, a card number, a privilege level, and the date/time it was generated. Such a membership card (not shown) may also have a magnetic strip or bar code, and account/membership data may be encoded within the magnetic strip or bar code.

Processing 110 at least a portion of identity 42 may also include associating 124 a Personal Identification Number (i.e., PIN) with the account or membership card (not shown). If a PIN is associated 124 with a membership card (not shown), it may be a newly generated 120 membership card (not shown) as discussed above or it may be a previously existing membership card (not shown). In either case, patron 12 may select a PIN and manually enter it into stationary device 16 and/or handheld device 18 through, e.g., a keypad (not shown) or touch screen (not shown). Alternatively, promotional association system 10 may generate a PIN at random. The PIN may be used to confirm that a future user either is patron 12 or is an authorized user of the account. For example, at a later date the membership card (not shown) may be swiped in a card reader and the user may be asked to enter their PIN as confirmation (e.g., by membership system 48) that the user of the membership card (not shown) is either patron 12 or is authorized to use the account or membership.

Although promotional association system 10 has been described as generating 120 a membership card (not shown) and associating 122 a PIN, it is understood that neither is generally required nor is either dependent upon the other. Even in the case of a new account, a membership card (not shown) does not necessarily need to be generated 120 by promotional association system 10, nor does a PIN necessarily need to be associated 124 with the account/membership card (not shown). Accordingly, for either a new or existing account, a membership card (not shown) may be generated 120 without associating 124 a PIN, and a PIN may be associated 124 without generating 120 a membership card (not shown).

As discussed above, processing 110 at least a portion of identity 42 may include defining membership data 46. Examples of information contained within membership data 46 may include but are not limited to: identity 42, other identifying information of patron 12, account numbers/identifiers, membership card numbers/identifiers, and Personal Identification Numbers. Promotional association system 10 may store membership data 46 (e.g., on any of storage devices 20, 22, 28) for subsequent retrieval and/or future processing. Additionally, promotional association system 10 may immediately, or at some future time, provide all (or a portion of) membership data 46 to a membership system (e.g., membership system 48) or a promotions system (e.g., promotions system 52).

Promotional association system 10 (i.e., client-side promotional association system 10C and/or server-side promotional association system 10S) may associate 126 patron 12 with a group. The association 126 may be achieved by associating 126 the account or identity 42 with the group. Promotional association system 10 may retrieve information about a group from a promotions system (e.g., promotions system 52), which may maintain a promotions database (not shown) or a group management database (not shown). Such group information may include but is not limited to: group identification number, group name, date/time information, or location information. Alternatively, promotional association system 10 may be manually configured with such group information by e.g., employee 44.

A group may refer to a group of patrons who have something in common. Groups may be defined according to the needs and decisions of marketing and/or business concerns. Examples of groups may include but are not limited to: patrons who arrive together on the same transportation means (e.g., via a bus); patrons who respond to, accept, or otherwise participate in some offer (e.g., a promotional advertisement); and patrons who respond to, attend, or participate in some promotional event (e.g., a promotional weekend Texas Hold'em poker competition).

For example and as discussed above, a group of patrons (including patron 12) may arrive on a particular bus together (e.g., bus 14). As another example, a group of patrons (including patron 12) may each arrive on different days or at different times, each to redeem their copy of a particular coupon or voucher (not shown). Further, a group of patrons (including patron 12) may each go to a particular location on the same day and at the same time for a raffle, drawing or other promotional event. It may be desirable to associate 126 each of these patrons with the group. Accordingly, promotional association system 10 may be utilized to effectuate this association 126.

While promotional association system 10 has been described as associating 126 patron 12 (e.g., via the account and/or all or a portion of identity 42) with a particular group, it is understood that patron 12 may be associated 126 with multiple groups. For example, patron 12 may participate in multiple promotional events, on the same day or over a period of time, or patron 12 may arrive with a bus group on more than one occasion. Accordingly, this disclosure should not be interpreted as limiting patron 12 to being associated 126 with only one group.

Associating 126 patron 12 with the group may include defining group association data 54. Examples of information contained within group association data 54 may include but are not limited to: an account identifier, record number, all or a portion of identity 42, event identifiers (e.g., group identification number, group name, etc.), company name(s), cost/financial data, location, and date/time information. Promotional association system 10 may store group association data 54 (e.g., on any of storage devices 20, 22, 28) for subsequent retrieval and/or future processing. Additionally, promotional association system 10 may immediately, or at some future time, provide all (or a portion of) group association data 54 to a membership system (e.g., membership system 48) or a promotions system (e.g., promotions system 52).

Promotional association system 10 may also issue 128 a promotional credit. It may be desirable to issue 128 a promotional credit for use by patron 12 as a benefit of being associated 126 with the group. The promotional credit may be a promotional dollar amount or an incentive or entitlement redeemable at the establishment. Examples of promotional credits may include but are not limited to: an amount of money to be credited for expenditures, an entitlement to a gift, or the privilege of participating in a promotional event. The promotional credit may be associated with the account or with the group.

Promotional association system 10 (i.e., client-side promotional association system 10C and/or server-side promotional association system 10S) may issue 128 such a promotional credit by e.g., providing details of the promotional credit to membership system 48 either included within membership data 46, or alternatively in a separate data structure or protocol. Membership system 48 may maintain a database (not shown) of promotional credits. Alternatively, promotional association system 10 may provide details of the promotional credit to promotions system 52 either included within group association data 54 or in a separate data structure or protocol. In another embodiment, promotional association system 10 may store the details of a promotional credit and provide them, or an approval or authorization to redeem them, at a future time when patron 12 desires to redeem the promotional credit.

As mentioned above, promotional association system 10 may store membership data 46 for future processing and/or for providing 130 to membership system 48. For example, server-side promotional association system 10S may store membership data 46 on storage device 28 coupled to server computer 24. The stored membership data 46 may include, but is not limited to: all or a portion of identity 42, account identifier data (e.g., account number), associated membership card(s) data, associated PINs (in clear or encrypted form), promotional credit information, or any other information that is desired/required by local procedure(s), such as the identity of the authorized user (e.g., employee 44), date and time data, control/validation data, and the identity of stationary device 16 and/or handheld device 18. Further, server-side promotional association system 10S may provide 130 all (or a portion of) membership data 46 to membership system 48 either immediately or at some future time.

Promotional association system 10 may provide 130 all (or a portion of) membership data 46 to membership system 48 through any of a number of different interfaces and mechanisms. For example, stationary device 16 and/or handheld device 18 (i.e., the device that executes client-side promotional association system 10C) or server computer 24 (i.e., the computer that executes server-side promotional association system 10S) may transmit all (or a portion of) membership data 46 to the device where membership system 48 is executed. This transmission may occur via a cabled interface (e.g., a local area network, an RS-232 interface, a Universal Serial Bus (USB) interface, or an IEEE 1394 interface) or, alternatively, via a wireless interface (e.g., wireless communication channel 36 between wireless access point 34 and handheld device 18) in conjunction with e.g., network 26.

Also as discussed above, promotional association system 10 may store group association data 54 for future processing and/or for providing 132 to promotions system 52. For example, server-side promotional association system 10S may store group association data 54 on storage device 28 coupled to server computer 24. The stored group association data 54 may include, but is not limited to: account identifier data (e.g., account number), record numbers, all or a portion of identity 42, event identifiers (e.g., group identification number, group name, etc.), promotional credit information, company name(s), cost/financial data, location, date/time information, or any other information that is desired/required by local procedure(s), such as the identity of the authorized user (e.g., employee 44), control/validation data, and the identity of stationary device 16 and/or handheld device 18.

Further, server-side promotional association system 10S may provide 132 all (or a portion of) group association data 54 to promotions system 52 either immediately or at some future time. Promotional association system 10 may provide 132 all (or a portion of) group association data 54 to promotions system 52 through any of a number of different interfaces and mechanisms. For example, stationary device 16 and/or handheld device 18 (i.e., the device that executes client-side promotional association system 10C) or server computer 24 (i.e., the computer that executes server-side promotional association system 10S) may transmit all (or a portion of) group association data 54 to the device where promotions system 52 is executed. This transmission may occur via a cabled interface (e.g., a local area network, an RS-232 interface, a Universal Serial Bus (USB) interface, or an IEEE 1394 interface) or, alternatively, via a wireless interface (e.g., wireless communication channel 36 between wireless access point 34 and handheld device 18) in conjunction with e.g., network 26.

It will be understood that membership system 48 and promotions system 52 are not themselves part of promotional association system 10. Accordingly, references to membership system 48 and promotions system 52 are for the convenience of referring to the functionalities as discussed herein. It is beyond the scope of this disclosure to completely define such systems or their architecture. In particular, the functionalities of membership system 48 and promotions system 52 may be consolidated into a single system (not shown) or may be distributed across multiple platforms. Further, the functionalities described may be implemented within other systems, or the systems may be known by other names. Accordingly, nothing in this disclosure should be interpreted as limiting the functionalities of promotional association system 10 based upon this reference in the disclosure to membership system 48, promotions system 52, or the functionalities of either.

It will be understood that the processes and functions described herein as part of promotional association system 10 may be executed anywhere and on any device or system, consolidated or distributed, capable of performing the processes and functions recited. Specifically, either of client-side promotional association system 10C or server-side promotional association system 10S, or their constituent parts and equipment, may be incorporated together into fewer systems or devices, or incorporated into other systems and devices (e.g., membership system 48 or promotions system 52), or may be separated and distributed across multiple systems and devices beyond that shown.

A number of implementations have been described. Nevertheless, it will be understood that various modifications may be made. Accordingly, other implementations are within the scope of the following claims.

What is claimed is:

1. A method comprising:
defining an identity of a patron of a casino;
determining whether the patron has an account within the casino;
if the patron has an account:
determining the account associated with the patron;
if the patron does not have an account:
generating an account, and
associating the account with the patron; and
associating the account with a group of patrons.

2. The method of claim 1 wherein defining an identity of a patron includes processing encoded data to define the identity.

3. The method of claim 1 wherein defining an identity of a patron includes defining the identity on a handheld device.

4. The method of claim 1 further comprising generating a membership card and associating the membership card with the account.

5. The method of claim 1 further comprising associating a personal identification number with one or more of the account and a membership card.

6. The method of claim 1 further comprising issuing a promotional credit.

7. The method of claim 1 wherein associating the account with the patron includes defining one or more of membership data and group association data, and further comprising:
providing the one or more of membership data and group association data to one or more of a membership system and a promotions system.

8. A system configured to perform operations comprising:
defining an identity of a patron of a casino;
determining whether the patron has an account within the casino;
if the patron has an account:
determining the account associated with the patron;
if the patron does not have an account:
generating an account, and
associating the account with the patron; and
associating the account with a group of patrons.

9. The system of claim 8 wherein defining an identity of a patron includes processing encoded data to define the identity.

10. The system of claim 8 wherein defining an identity of a patron includes defining the identity on a handheld device.

11. The system of claim 8 further configured to perform operations comprising generating a membership card and associating the membership card with the account.

12. The system of claim 8 further configured to perform operations comprising associating a personal identification number with one or more of the account and a membership card.

13. The system of claim 8 further configured to perform operations comprising issuing a promotional credit.

14. The system of claim 8 wherein associating the account with the patron includes defining one or more of membership data and group association data, and further comprising:
providing the one or more of membership data and group association data to one or more of a membership system and a promotions system.

15. A computer program product residing on a computer readable medium having a plurality of instructions stored thereon, which, when executed by one or more processors, cause the one or more processors to perform operations comprising:
defining an identity of a patron of a casino;
determining whether the patron has an account within the casino;
if the patron has an account:
determining the account associated with the patron;
if the patron does not have an account:
generating an account, and
associating the account with the patron; and
associating the account with a group of patrons.

16. The computer program product of claim 15 wherein defining an identity of a patron includes processing encoded data to define the identity.

17. The computer program product of claim 15 wherein defining an identity of a patron includes defining the identity on a handheld device.

18. The computer program product of claim 15 further configured to perform operations comprising generating a membership card and associating the membership card with the account.

19. The computer program product of claim 15 further configured to perform operations comprising associating a personal identification number with one or more of the account and a membership card.

20. The computer program product of claim 15 further configured to perform operations comprising issuing a promotional credit.

21. The computer program product of claim 15 wherein associating the account with the patron includes defining one or more of membership data and group association data, and further comprising:
providing the one or more of membership data and group association data to one or more of a membership system and a promotions system.
